(19) United States
(12) Patent Application Publication
(10) Pub. No.: US 2024/0040419 A1
(43) Pub. Date: Feb. 1, 2024

(54) UPLINK BASED RADIO RESOURCE MANAGEMENT PROCEDURE

(71) Applicant: MEDIATEK INC., Hsinchu (TW)

(72) Inventors: Chia-Hao Yu, Hsinchu (TW); Din-Hwa Huang, Hsinchu (TW); Pei-Kai Liao, Hsinchu (TW)

(21) Appl. No.: 18/220,375

(22) Filed: Jul. 11, 2023

Related U.S. Application Data
(60) Provisional application No. 63/369,392, filed on Jul. 26, 2022.

(51) Int. Cl. H04W 24/10; H04L 5/00; H04W 36/00

(52) U.S. Cl. CPC H04W 24/10; H04L 5/0051; H04W 36/0085

(57) ABSTRACT

In an aspect of the disclosure, a method, a computer-readable medium, and a wireless communication system including a control device and one or more cells are provided. The control device configures triggering conditions for a user equipment (UE) to initiate transmission of specific uplink (UL) reference signals for UL radio resource management (RRM) measurements. The one or more cells detect the specific UL reference signals transmitted by the UE on specific UL RRM resources based on a reference timing when the triggering conditions are met at the UE. The one or more cells measure the specific UL reference signals to obtain measurement results. The control device decides for a carrier change or a cell change based on the measurement results of the one or more cells. The control device indicates to the UE a set of selected cells or carriers for the UE to connect.

### CROSS-REFERENCE TO RELATED APPLICATION(S)

This application claims the benefits of U.S. Provisional Application Ser. No. 63/369,392, entitled “UL BASED RRM PROCEDURE” and filed on Jul. 26, 2022. The contents of the application above are expressly incorporated by reference herein in their entirety.

### BACKGROUND

### Field

The present disclosure relates generally to communication systems, and more particularly, to techniques of utilizing uplink-based radio resource management (RRM) measurements for cell/radio unit switch.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and a wireless communication system including a control device and one or more cells are provided. The control device configures triggering conditions for a user equipment (UE) to initiate transmission of specific uplink (UL) reference signals for UL radio resource management (RRM) measurements. The one or more cells detect the specific UL reference signals transmitted by the UE on specific UL RRM resources based on a reference timing when the triggering conditions are met at the UE. The one or more cells measure the specific UL reference signals to obtain measurement results. The control device decides for a carrier change or a cell change based on the measurement results of the one or more cells. The control device indicates to the UE a set of selected cells or carriers for the UE to connect.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating an open radio access network (RAN) architecture.

FIG. 8 is a diagram illustrating a handover process utilizing UL RRM measurements.

FIG. 9 is a flow chart of a method (process) for performing UL RRM measurements.

FIG. 10 is a flow chart of another method (process) for performing UL RRM measurements.

FIG. 11 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

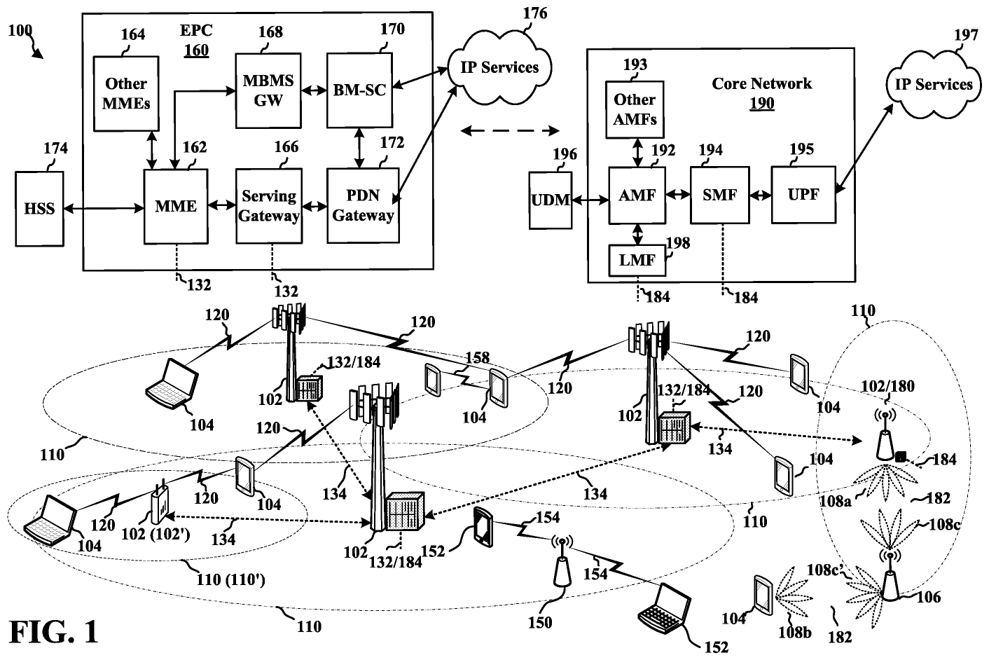

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

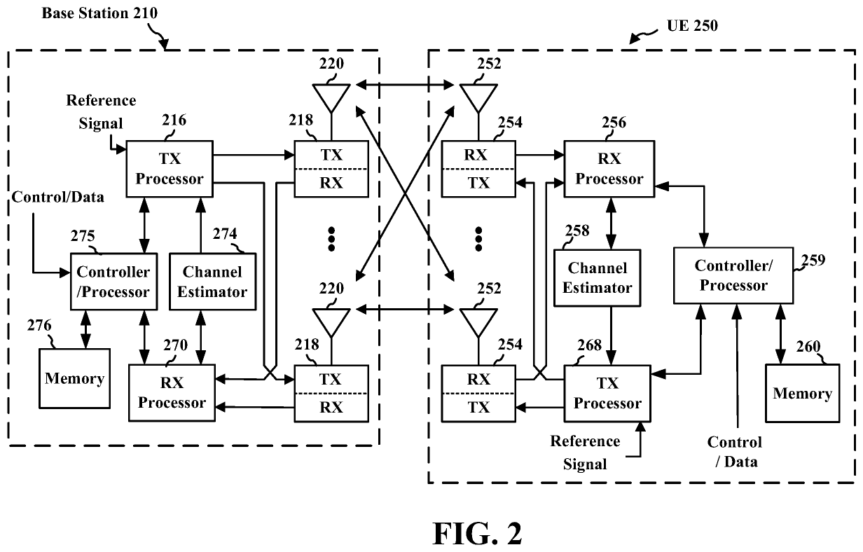

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

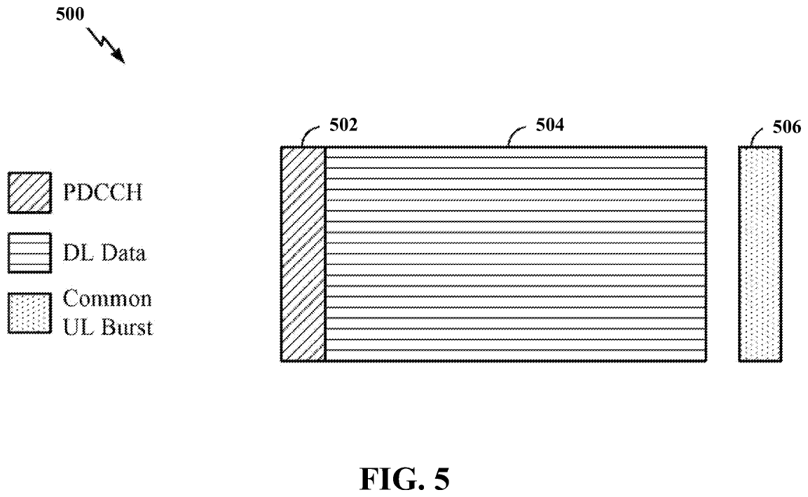

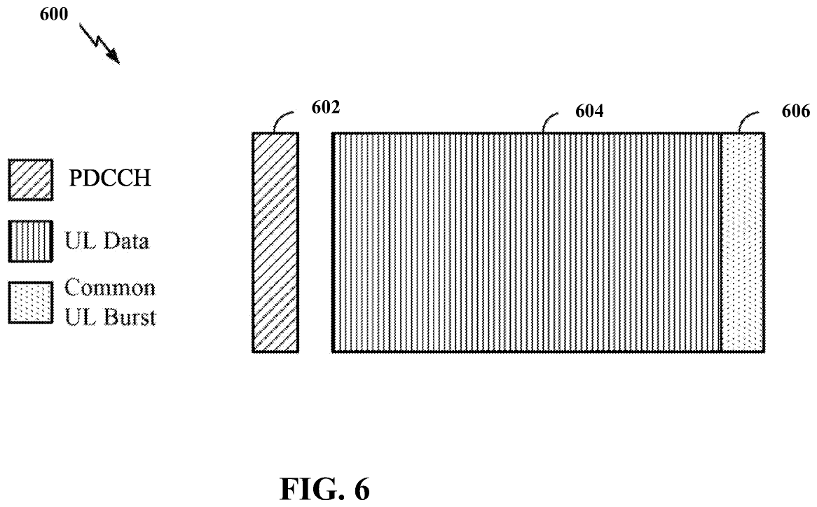

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

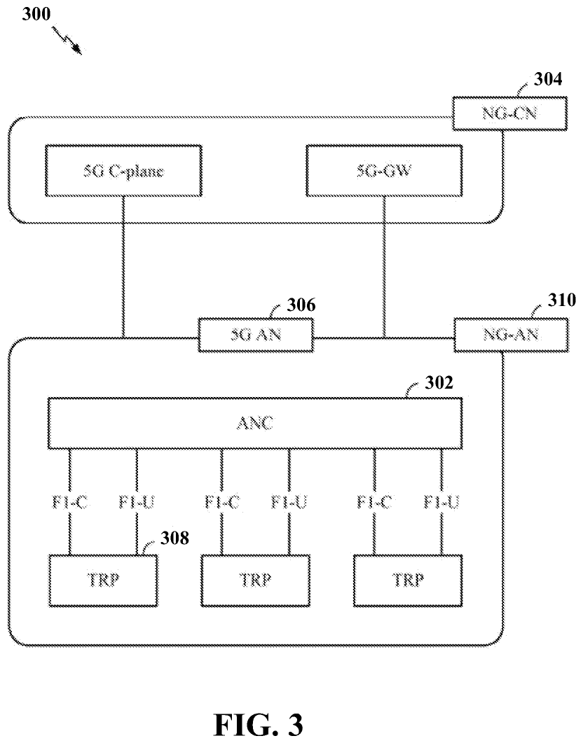

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

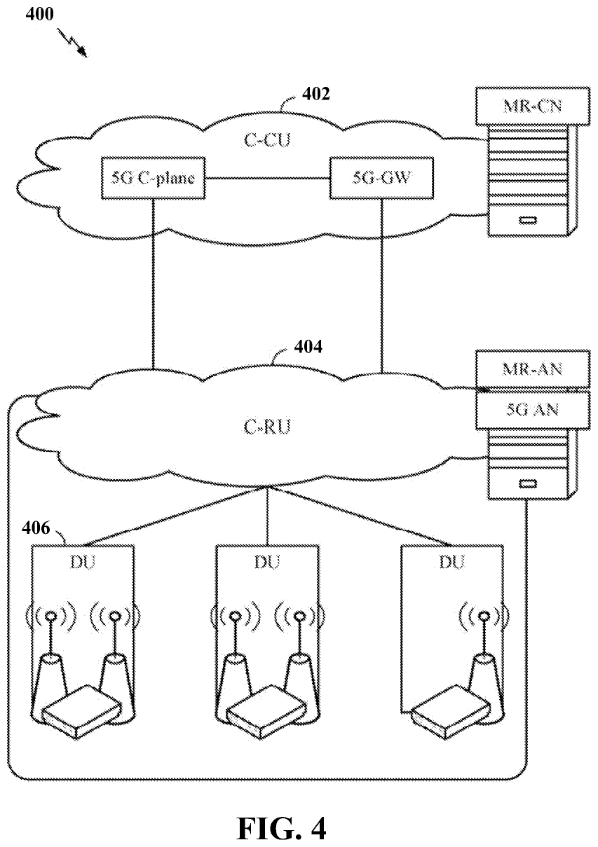

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

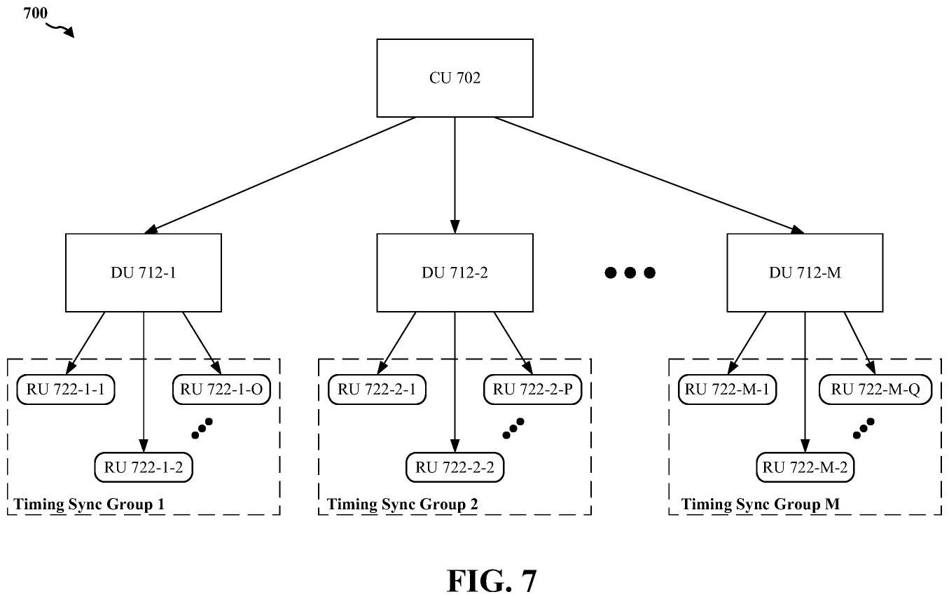

FIG. 7 is a diagram 700 illustrating an open radio access network (RAN) architecture. Open RAN is a concept that aims to create a more open and flexible architecture for wireless networks, particularly for 5G and beyond. Traditionally, RANs have been built using proprietary hardware and software, making it difficult for operators to mix and match components from different vendors. Open RAN seeks to break down these barriers and enable operators to build RANs using off-the-shelf hardware and software from multiple vendors. Open RAN is based on a software-defined architecture, which allows for greater flexibility and agility. In this example, the open RAN architecture is divided into three primary layers: a Centralized Unit (CU) 702; Distributed Units (DUs) 712-1 to 712-M located below the CU 702; and Radio Units (RUs) 722-1-1 to 722-1-O, 722-2-1 to 722-2-P, and 722-M-1 to 722-M-Q, which are controlled by their respective DUs. Each layer can be implemented using different hardware and software components provided by different vendors, as long as they are in compliance with open interfaces and protocols.

The CU 702 is responsible for overall network management and coordination including control of radio resource control (RRC) and packet data convergence protocol (PDCP) layers. It is usually located in a centralized data center or cloud. The CU 702 can be implemented using cloud-based software running on standard servers. The CU 702 are in communication with the DUs 712-1 to 712-M and is responsible for functions such as network slicing, mobility management, and load balancing.

The DUs 712-1 to 712-M may provide additional processing and management functions for the radio access network, including management of certain radio link control (RLC), media access control (MAC), and partial physical layer parameters such as modulation and coding schemes (MCS), transmit power levels, and carrier aggregation. The DUs 712-1 to 712-M are typically located closer to the cell site than the CU 702, and can be implemented using standard servers and software. The DUs 712-1 to 712-M are in communication with the RUs 722-1-1 to 722-1-O, 722-2-1 to 722-2-P and 722-M-1 to 722-M-Q, respectively. The DUs 712-1 to 712-M are responsible for functions such as radio resource management, scheduling, and interference management. The DUs 712-1 to 712-M may share the same RLC and PDCP parameters.

Radio Units (RUs) represent the physical layer of the Open RAN architecture and are responsible for specific digital frontends and partial physical layer parameters, particularly focusing on digital beamforming functionality. The RUs are usually located at the cell site and communicates directly with mobile devices over the air interface. The RUs can be implemented using off-the-shelf hardware such as x86 processors and field-programmable gate arrays (FPGAs) and can support multiple bands and technologies such as LTE, 5G, 6G, and Wi-Fi. More specifically, the RUs 722-1-1 to 722-1-O function together in a synchronized manner in a timing sync group 1 under the control of the DU 712-1 and share the same MAC and RLC parameters; the RUs 722-2-1 to 722-2-P function together in a synchronized manner in a timing sync group 2 under the control of the DU 712-2 and share the same MAC and RLC parameters; the RUs 722-M-1 to 722-M-Q function together in a synchronized manner in a timing sync group M under the control of the DU 712-M and share the same MAC and RLC parameters.

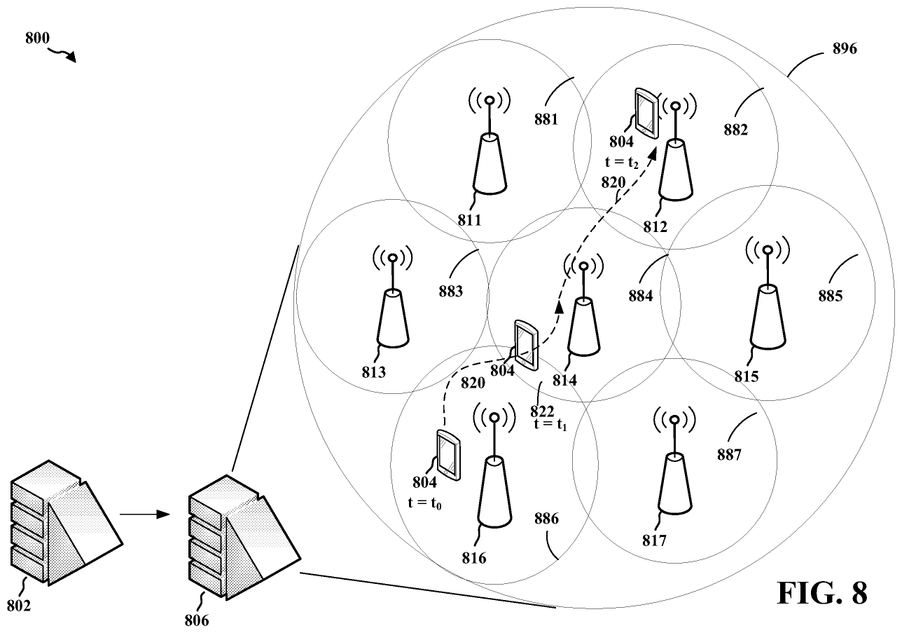

FIG. 8 is a diagram 800 illustrating a handover process utilizing UL RRM measurements. In this example, a CU 802 controls a DU 806, which in turn controls RUs 811-817 having RU coverage areas 881-887, respective. Those RU coverage areas together form a DU coverage area 896. At time t₀, a UE 804 is located in the RU coverage area 886 and connected to the RU 816. Subsequently, at time t₁, the UE 804 has moved into an overlapping area 822 of the RU coverage area 886 of the RU 816 and the RU coverage area 884 of the RU 814. Through a handover process, the UE 804 is handed over from the RU 816 to the RU 814.

In this specific example, the CU 802, the DU 806, and RUs 811-817 are exemplary devices implementing various functions supporting UL RRM measurements procedures. In other examples, other control devices may replace the CU 802 and/or DU 806 to provide UL RRM measurements control and management functions.

Further, a cell (base station) or a TRP may replace an RU to provide network connectivity or radio access to the UE 804. Accordingly, an RU coverage may be replaced by a cell coverage or a TRP coverage. An RU ID may be replaced by a cell ID or a TRP ID.

The legacy handover process relies on downlink (DL)-based radio resource management (RRM) measurements. DL-based RRM measurements involve the user equipment (UE) measuring the signal strength, quality, and other parameters of the DL signals received from neighboring RUs. DL-based RRM measurements require specific time intervals or gaps during which the UE can measure the DL signals. In dense network environments or high-mobility scenarios, finding suitable measurement gaps may be challenging, affecting the accuracy and timeliness of DL-based measurements. Further, DL-based RRM measurements need to be collected, processed, and analyzed by the network before making a handover decision. This process introduces a certain amount of latency, which can impact the handover performance, particularly in fast-moving scenarios or situations requiring rapid handover execution.

To improve the handover process, the UE 804 may implement a handover process based on uplink (UL)-based RRM measurements. UL RRM measurements involve the measurement of uplink parameters such as received signal strength, signal quality, and interference levels. These measurements help in assessing the performance of neighboring RUs and determining suitable target RUs for handover. UL RRM contributes to the handover triggering decision. The CU 802/DU 806 monitors the uplink quality indicators and may trigger a handover process when certain predefined thresholds or criteria are met. UL RRM assists in the selection of the target RU for handover. The CU 802/DU 806 considers factors such as the uplink quality of neighboring RUs, available resources in the target RU, and the UE's requirements and capabilities. The target RU is chosen based on criteria that aim to improve link performance and to provide seamless continuity of the UE's communication.

In a first stage of a first technique, the CU 802 sends an indication to the UE 804 that UL RRM measurements are feasible for facilitating a handover procedure. Accordingly, when certain triggering conditions are met, the UE 804 may send a request to the CU 802 to initiate a UL RRM measurements procedure. In other configurations, alternatively or in addition, the DU 806 or other control devices of the network may also perform those UL RRM measurements control/management functions. That is, the various UL RRM measurements control/management functions described in the present disclosure may be implemented by the CU 802, the DU 806, and/or other control devices in the network.

In this technique, the indication may also specify the triggering conditions. The triggering conditions may include a serving RU signal quality criterion triggering condition. In this example, the UE 804 initially is within the RU coverage area 886 of the RU 816 and is connected to the RU 816. Subsequently, at time t₁, the UE 804 moved into the overlapping area 822 as described supra. The UE 804 is still connected to the RU 816. The UE 804 measures quality of DL signals carrying information known to the UE 804 (e.g., DL reference signals for measurement) and/or DL signals carrying information unknown to the UE 804 (e.g., PDCCH or PDSCH) transmitted from the RU 816 to determine one or more of Reference Signal Received Power (RSRP), Reference Signal Received Quality (RSRQ), Signal-to-Noise Ratio (SNR), Signal-to-Interference-plus-Noise Ratio (SINR), or hypothetic Block Error Rate (BLER). The UE 804 may be configured with a reference threshold for each measurement. When the one or more of the measurements do not meet their reference thresholds (e.g., are not better or are worse than the reference thresholds), respectively, the UE 804 may determine that the serving RU signal quality triggering condition is met, as the qualities of the signals from the RU 816 are not good enough.

Further, the triggering conditions may include a mobility criterion triggering condition. In this example, the UE 804 may determine measurement changes such as ΔRSRP, ΔRSRQ, ΔSNR, or ΔSINR etc. within a certain given period of time T (e.g., from t₀ to t₁). More specifically, those measurement changes may be define as:
ΔRSRP=RSRP_{reference}−RSRP_{measured currently}, where RSRP_{reference} can be the maximal RSRP within T or RSRP measured at the starting time of T;
ΔRSRQ=RSRQ_{reference}−RSRQ_{measured currently}, where RSRQ_{reference} can be the maximal RSRQ within T or RSRQ measured at the starting time of T;
ΔSNR=SNR_{reference}−SNR_{measured currently}, where SNR_{reference} can be the maximal SNR within T or SNR measured at the starting time of T;
ΔSINR=SINR_{reference}−SINR_{measured currently}, where SINR_{reference} can be the maximal SINR within T or SINR measured at the starting time of T.

The UE 804 may be configured with a respective reference threshold for each of the measurement differences; ΔRSRP, ΔRSRQ, ΔSNR, or ΔSINR. When a measurement change is no less or larger than the corresponding reference threshold, the UE 804 may determine that the UE mobility triggering condition is met, as the UE 804 is considered as moving too fast.

In certain configurations, if no triggering condition is provided to the UE 804 by the CU 802, the UE 804 may use its own evaluation to define a triggering condition.

The UE 804 may be configured to enter a second stage when any one of triggering conditions is satisfied, a predetermined subset of the triggering conditions is satisfied, or all of the triggering conditions are satisfied.

In this example, at t₁, the UE 804 is located in the overlapping area 822 and determines that the RSRP is below the reference threshold. As configured, the UE 804 determines that a required triggering condition is satisfied and, thus, enters a second stage.

In the second stage, a UE 804 send a UL RRM request to the CU after determining that one or more required triggering conditions specified by the CU or determined by the UE itself are satisfied. In this example, the UE 804 sends a UL RRM request to the CU 802. The UL RRM request indicates to the CU 802 that the UE 804 is triggered to use UL RRM measurements to assist the handover process.

In certain configurations, the UL RRM request may be an indicator in uplink control information (UCI) carried on a Physical Uplink Control Channel (PUCCH) and/or a Physical Uplink Shared Channel (PUSCH). In certain configurations, the UL RRM request may be carried in a Medium Access Control Control Element (MAC-CE).

Further, the UL RRM request may include serving RU (e.g., the RU 816) signal quality information such as Reference Signal Received Power (RSRP) or other measurements such as those described supra. The UE 804 may include mobility-related information in the UL RRM request message. This information can indicate the UE's mobility state, velocity, or other parameters that can help the network optimize handover or resource allocation based on the UE's movement.

In addition, the UL RRM request may include information of preferred UL RRM resources for sending the UL RRM reference signals. The preferred UL RRM resources may be identified by a configuration identifier corresponding to a preconfigured resource. The UL RRM request may specify the preferred or supported UL RRM resources.

The UL RRM request may include information on DL reception timing availability for neighboring RUs. This information is conveyed through indicators and/or corresponding RU IDs, indicating whether the DL synchronization towards neighboring RUs on a specific frequency, band, or TAG has been accomplished or not. The indicators can have values like “done” or “not done” to represent the status of DL synchronization. If the indicator is reported as “done,” it signifies that the CU can estimate the timing advance (TA) based on the transmitted UL RRM reference signals. This implies that the UE has achieved synchronization with the DL timing of the neighboring RUs on the specified frequency, band, or TAG.

On the other hand, if the indicator is reported as “not done,” it means that the CU cannot estimate the TA based on the transmitted UL RS. This suggests that the UE has not yet achieved synchronization with the DL timing of the neighboring RUs on the specified frequency, band, or TAG.

The UL RRM request may also include an indicator and/or corresponding RU ID per carrier, indicating the reference timing to be used for subsequent UL transmissions. If this information is not indicated initially, it can be one of the following options (not limited to):

1. Timing of a specific serving RU: The UE can specify the timing of a specific serving RU, such as the primary RU (PRU) (in one specific example, when a cell replaces an RU to provide radio access to the UE 804, the primary RU is replaced by a PCell), the primary secondary RU group RU (PSRU) (in one specific example, when a cell replaces an RU to provide radio access to the UE 804, the PSRU is replaced by a PSCell), or a particular secondary RU (SRU) (in one specific example, when a cell replaces an RU to provide radio access to the UE 804, the SRU is replaced by a SCell). This timing reference helps the network in coordinating UL transmissions with the specified serving RU.

2. Timing of target TAG for RU switch/handover/(P)SRU addition: The UE can indicate the timing of a target time advance group (TAG) for activities like RU switch, handover, or the addition of a PSRU or an SRU. This ensures proper timing alignment for UL transmissions related to these operations. A TAG is a group of RUs with the same timing advance settings, allowing coordinated timing adjustment for multiple RUs.

3. Timing of target RU for RU switch/handover/(P)SRU addition: The UE can provide the timing of a target RU for activities like RU switch, handover, or the addition of a PSRU or an SRU. This timing information guides UL transmissions during these procedures.

Overall, the UL RRM request serves as a means for the UE to communicate its uplink resource requirements, serving RU quality, mobility information, and preferences to the network. It enables the network to make informed decisions for resource allocation, handover, and optimization of the overall system performance.

In a third stage, the CU 802 responds to the UL RRM request and configures UL RRM resources for the UE 804 to transmit UL RRM reference signals. For example, the CU 802 may specify the desired parameters and configurations for the UL RRM reference signals. The UL RRM reference signals may be used for various purposes, including UL channel estimation, interference measurement, and UL synchronization.

The UE 804 may generate, on-demand, UL RRM reference signals and transmit them on the UL RRM resources configured by the CU 802. The on-demand reference signals are designed to provide accurate and up-to-date information about the UE's uplink transmission characteristics, such as channel conditions, power levels, and timing. This information is crucial for the CU to perform efficient UL RRM operations, such as handover decision-making, resource allocation, and interference management. The on-demand UL RRM reference signals may be customized based on the specific requirements of the network and the ongoing RRM procedures. The on-demand UL RRM reference signals may vary in terms of format, modulation scheme, transmit power, and transmission duration. The CU 802 utilizes the received on-demand reference signals to determine whether to handover the UE 804 from one RU to another RU.

Upon receiving the UL RRM request from the UE 804, the CU 802 configures an UL RRM resource/preamble for the UE 804. The CU 802 may provide the on-demand UL RRM configurations to the UE 804 via an RRC configuration, a MAC CE, or a DCI indication. The configurations for the UL RRM resource/preamble include various parameters and settings that dictate how the UE accesses and utilizes the uplink resources. For example, the configurations may specify UL resources, preambles (sequences), UL formats, transmission power, and/or reference timing. The configurations can be dynamic and adaptable to changing network conditions or specific requirements, allowing the CU to allocate and manage UL RRM resources efficiently.

In this example, the configurations for UL RRM resource/preamble may include the UE ID of the UE 804. The UE ID may be a unique dedicated identifier within the CU 802 for the UE 804. If the UE 804 is not configured with a dedicated UE ID, the combination of the RU ID and cell radio network temporary identifier (C-RNTI) can be used as the UE ID. Both options provide different ways to identify the UE 804 within the UL RRM resource/preamble configuration. The choice between a dedicated UE ID or the combination of RU ID and C-RNTI depends on the network configuration and requirements.

The configurations for UL RRM resource/preamble may specify that the UL RRM reference signals are sounding reference signals (SRSs). Accordingly, the configurations may include an SRS resource configuration. The SRS resource configuration specifies the parameters for the SRS transmission, including SRS bandwidth, SRS subframe configuration, SRS cyclic shift, and SRS antenna port(s).

Alternatively, the configurations for UL RRM resource/preamble may specify that the UL RRM reference signals are preambles associated a with physical random access channel (PRACH). The configurations may also include PRACH parameters, which may include transmission locations in both time and frequency domains that specify the time and frequency resources allocated for preamble transmissions. The configurations may also include a preamble sequence, which is a specific sequence of symbols used by the UE for PRACH transmission. The UE uses a unique preamble sequence to differentiate itself from other UEs and facilitate access and identification. The configurations may include a PRACH preamble format, which defines the structure and configuration of the PRACH preamble. The format includes information such as the number of subcarriers, duration, cyclic prefix length, and other parameters that determine the characteristics of the PRACH signal. The configurations may include payload location and a scrambling code for scrambling the payload. The payload location indicates where the actual data or payload is located within the PRACH transmission. Additionally, a scrambling code may be applied to the payload for scrambling purposes, ensuring data integrity and security during transmission.

The configurations for the UL RRM resource/preamble may include a reference timing for transmission on the UL RRM resource. The reference timing specifies the timing reference used for transmitting on the UL RRM resource, ensuring synchronization and alignment between the UE and the CU. The reference timing can be based on the reference timing of a specific serving RU. For instance, the UE may use the reference timing of a particular RU of the serving RU such as one of the PRU, PSRU, or a specific SRU. Using the reference timing of a specific serving RU allows the UE to synchronize its UL RRM resource transmission timing with the serving RU's timing. The reference timing can also be based on the reference timing of the target TAG for cell/RU switch, handover, or (P)SRU addition. In scenarios involving RU switching, handover, or the addition of a new (P)SRU, the UE may use the reference timing of the target TAG. Additionally, the reference timing can be based on the reference timing of the target RU for cell/RU switch, handover, or (P)SRU addition. In these cases, the UE may synchronize its UL RRM resource transmission timing with the reference timing of the target RU when performing cell/RU switch, handover, or (P)SRU addition procedures. This ensures proper coordination and alignment with the target RU's timing.

The configuration for the UL RRM resource/preamble may include a specific stopping condition for the transmission on the UL RRM resource. This stopping condition helps determine when the UE should cease transmitting on the UL RRM reference signals, thus managing the duration and termination of the transmission based on specified criteria or triggers. There are several situations when the transmission on the UL RRM resource may be halted, for example: 1. Upon receiving a further indication from the CU: In this case, the transmission may be stopped when the UE receives a specific signaling message or control instruction from the CU, indicating that the UE should cease transmitting on the UL RRM resource. 2. Upon reaching a predetermined number of transmission opportunities: This stopping condition may be employed to limit the duration or number of transmissions on the UL RRM resource, ensuring efficient resource utilization without overburdening the network. 3. Upon satisfying a certain triggered condition: This condition could be associated with the UE's operational state, network conditions, or specific events. For instance, the transmission may be stopped when the UE receives a handover or RU switch command, indicating a change in the UE's serving RU.

By including these stopping conditions in the RRC configuration for UL RRM resource/preamble, the CU can effectively manage the use of the UL RRM resource in a dynamic and adaptable manner, ensuring efficient allocation and utilization of resources while responding to changing network conditions and UE requirements.

The configuration for the UL RRM resource/preamble may include a transmission condition for transmitting the UL RRM reference signals. This transmission condition dictates when the transmission on the UL RRM resource should commence. A UE initiates the transmission based on distinct triggering conditions or configurations.

The transmission of the UL RRM reference signals may be configured to follow a periodic pattern. In such a case, the UE initiates transmissions on the UL RRM resource at regular intervals as specified by the RRC configuration. This periodicity ensures that a constant monitoring or reporting of specific information or measurements is achieved.

Transmissions can be prompted by specific conditions or events, which can be outlined by the network. Triggering conditions can vary depending on diverse factors and requirements, such as network conditions, radio measurements, data availability, or certain events. For example, the UE might trigger transmissions when quality of service (QoS) metrics, like throughput, latency, or error rates, exceed or dip below predetermined thresholds. This ensures that the UE initiates necessary transmissions when maintaining the desired QoS level becomes challenging.

Triggering conditions can also be based on radio measurements, such as signal strength, interference levels, or channel quality indicators. In cases where measured values reach a certain threshold or undergo significant change, the transmission on the UL RRM resource can be initiated to provide updated information to the network.

Additionally, transmissions may be prompted by specific events or triggers, such as the activation of certain applications or services, user interactions, or the receipt of specific signaling messages from the network. Configuring triggering conditions allows for dynamic and adaptive resource utilization, as it ensures that the transmission occurs at the most relevant or advantageous moments according to predefined criteria.

In some instances, the UE implementation may trigger transmissions without reliance on external commands or network triggers. The UE can initiate transmissions based on its internal logic or algorithms. In this scenario, the UE factors in internal measurements, data availability, unique UE capabilities, or other factors decided by the UE's design and functionality. This approach gives the UE more autonomy and flexibility in initiating transmissions based on its own internal decision-making processes. As a result, the UE can adjust to dynamic conditions, optimize resource usage, or support specific functionalities or applications that necessitate on-demand or self-triggered transmissions. Other options are not precluded.

In certain situations, the CU may be configured to provide multiple sets of on-demand UL RRM resources for the UE, each with distinct parameters or properties to meet specific requirements or operational conditions. This capability enables flexible resource allocation and optimization depending on the UE's needs or network policies. For instance, the CU 802 can designate one set of UL RRM resources for applications necessitating swift transmission, such as low-latency applications, while another set can be assigned for high-throughput applications. By offering varying sets of UL RRM resources, the CU ensures that the UE's particular requirements are fulfilled while effectively utilizing the accessible resources. Implementing multiple sets of on-demand UL RRM resources enhances adaptability, resource management, and optimization within the Open RAN architecture. This feature enables tailored resource allocation to accommodate various application demands, network conditions, and UE capabilities.

In this example, after receiving the UL RRM request from the UE 804 through the RU 816 and DU 806, the CU 802 transmits an RRC configuration message to the UE 804. The RRC configuration message specifies that the UE 804 should transmit PRACH preambles as UL RRM reference signals. Additionally, the message specifies the resources/occasions to be employed for sending the preambles and the format of the preamble. As a result, the UE 804 may transmit preambles while located in the overlapping area 822. These preambles can be received by the serving RU 816 as well as by multiple neighboring RUs, such as RU 813, RU 814, and RU 817. The DU 806 obtains preamble configurations from the CU 802 and subsequently directs RU 816, RU 813, RU 814, and RU 817 to measure the preambles transmitted by the UE 804.

In a fourth stage, once configured by the CU 802, the UE 804 is prepared to transmit the preamble on the UL RRM resource according to the provided configuration and a reference timing. Upon meeting the transmitting condition configured in the third stage, the transmission commences. The UE 804 initiates the preamble transmission on the UL RRM resources determined according to the reference timing. To transmit the preamble on the target UL RRM resource with M transmitting beams, the UE 804 can implement two methods. In the first method, the UE 804 utilizes the first transmitting beam to transmit the preamble on the UL RRM resource N times before switching to the subsequent transmitting beam for the following N times. This process is repeated until all M transmitting beams have been used. In the second method, the UE 804 employs M different transmitting beams to transmit the same preamble on the same UL RRM resource and repeats this in the same beam-switching order for N times. For example, N may be 4.

The UE 804 transmits the preamble based on the configured reference timing if it is specified. If the reference timing is not explicitly configured, the UE 804 may use the reference timing of a specific RU of the serving RU (e.g., a PRU, PSRU, or particular SRU of the RU 816), the reference timing of the target TAG for RU switch/handover/(P)SRU addition, or the reference timing of the target RU1 for RU switch/handover/(P)SRU addition to determine when to transmit the preamble. The UE 804 can also utilize other reference timing options.

In a fifth stage, the RUs surrounding the UE measures the UL RRM reference signals transmitted by the UE in the fourth stage. In this example, the UE 804 transmits preambles while located in the overlapping area 822. The serving RU 816 and the neighboring RUs 813, 814, 817, in proximity, may receive the preambles. Those RUs measures the received preambles (i.e., the UL RRM reference signals) and reports the measurement results to the CU 802. The CU 802 then compares the RSRP of the preambles collected from different RUs and decides whether a handover is necessary based on the UL RRM results measured by RUs, DL-based RRM results reported by the UE 804, or a combination of both UL and DL-based RRM results that would lead to a neighboring RU with improved DL performance and more favorable UL channel conditions. For example, if the DL-based RRM results indicate deteriorating DL channel quality in the RU 816 and the UL RRM results suggest that the RU 814 has the best UL channel condition, the CU 802 may initiate a handover to the RU 814 from the RU 816 for the UE 804.

Subsequently, in a sixth stage, the CU 802 initiates commences the RU/cell switch/handover/(P)SRU addition process by informing the UE 804 of the next target RU (e.g., a particular RU 814), which the UE 804 then proceeds to connect with. In certain configurations, RU switch means swapping the roles of a PRU and a SRU. During this process, the RU Switch/Handover/(P)SRU addition command instructs the UE 804 to establish a connection with the target RU 814 and transfer control and user plane data accordingly. This command may also include the UE ID to ensure that the CU 802 specifically addresses the appropriate UE 804 without confusion or misinterpretation by other UEs in the network. The UE ID could be a temporary identifier assigned during the random access procedure or a permanent identifier like an IMSI or device-specific identifier.

The RU Switch/Handover/(P)SRU addition command may contain the identifier of a UL RRM resource with preferred measurement results, enabling the UE 804 to recognize and configure its transmission parameters accordingly. This information might involve details about the preferred UL beam or beam index that the UE 804 used when transmitting on the specified UL RRM resource. Hence, the UE 804 may use the same beam for transmitting signals to the target RU.

The command may also include an identifier, such as a physical RU ID (in one specific example, when a cell replaces an RU to provide radio access to the UE 804, the RU ID is replaced by PCI) or RU global ID (in one specific example, when a cell replaces an RU to provide radio access to the UE 804, the RU global ID is replaced by CGI), indicating the target RU identity for handover, RU switch, or (P)SRU addition. Additionally, the command may include information contained in a Message 2 (i.e., a random access response (RAR)) in a random access procedure. The information may specify UE ID (either TC-RNTI or the UE-ID within the UL RRM resource/preamble configuration), TA command, and UL grant for Message 3 in the random access procedure.

After receiving the RU switch/handover/(P)SRU addition command, the UE 804 initiates the specified process, which may involve handover, RU switch, or (P)SRU addition. The UE 804 applies the RRC configuration of the target RU. The UE 804 also starts monitoring data through the indicated UE beam associated with the UL RRM resource identifier. In some instances, the UE 804 may need to perform a search for the target RU ID to establish downlink synchronization.

Alternatively, during the handover/RU switch/(P)SRU addition process, the UE may remain within the source RU's RRC configuration while switching its Rx beam associated with the UL RRM resource identifier to receive data from the target RU.

The UE 804 receive from the target cell/RU the target RU configuration through the RRC reconfiguration.

In a second technique, the UE 804 may perform modified operations of the six stages of the first technique in order to perform UL RRM measurements. More specifically, in the first stage of the second technique, the UE 804 performs all operations in the first stage of the first technique. That is, the CU 802 sends an indication to the UE 804 that UL RRM measurements are feasible for facilitating a handover procedure. The indication may also specify the triggering conditions.

In addition, in the first stage of the second technique, the UE 804 also performs operations in the third stage of the first technique that configures UL RRM resources for the UE 804 to transmit UL RRM reference signals. As described supra, the CU 802 may use RRC configurations to specify configurations of the UL RRM resources and UL RRM reference signals. In particular, the configurations specify the UE ID, the selection of UL RRM reference signals (e.g., SRS or preamble), the reference timing, the stopping condition, and the transmitting condition.

In the second stage of the second technique, the UE 804 performs the operations in the second stage of the first technique. In particular, the UE 804 sends a UL RRM request to the CU 802 when the triggering condition is met.

In the third stage, the CU 802 send a confirmation message to the UE 804. The confirmation message may indicate a subset of the UL RRM resources configured for the UE 804 in the first stage. The subset of the UL RRM resources is to be used by the UE 804 to transmit UL RRM reference signals. The confirmation message also indicates the reference timing to be used for subsequent UL transmission, if the reference timing is not indicated to the UE 804 in stage 1.

Subsequently, the UE 804 performs, in the fourth stage to the sixth stage of the second technique, the same operations as described supra in the fourth stage to the sixth stage of the second technique.

In certain configurations, the UE 804 may skip operations in the second stage. In certain configurations, the UE may skip operations in both the second stage and the third stage.

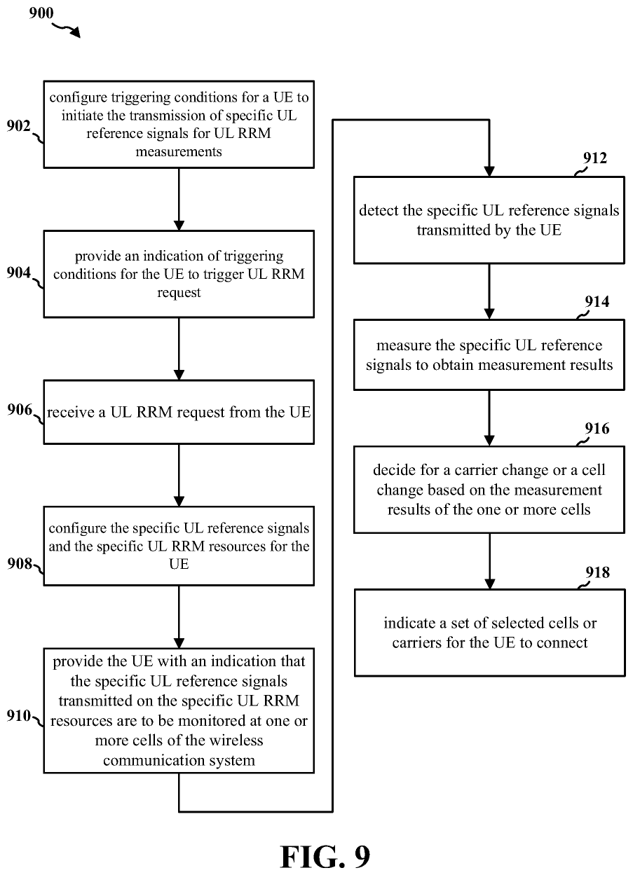

FIG. 9 is a flow chart 900 of a method (process) for performing UL RRM measurements. The method may be performed by a wireless communication system. In operation 902, a control device of the wireless communication system configures triggering conditions for a UE to initiate the transmission of specific UL reference signals for UL RRM measurements. In operation 904, the control device provides an indication of triggering conditions for the UE to trigger the UL RRM request. In certain configurations, the triggering conditions include at least one of a serving RU quality criterion and a mobility criterion. The serving RU quality criterion is based on at least one of Reference Signal Received Power (RSRP), Reference Signal Received Quality (RSRQ), Signal-to-Noise Ratio (SNR), Signal-to-Interference-plus-Noise Ratio (SINR), or hypothetic Block Error Rate (BLER) being no better or worse than a given threshold. The mobility criterion is based on a change of at least one of RSRP, RSRQ, SNR, or SINR being no less or larger than a given threshold measured within a certain period of time. The triggering conditions define that the UE is to initiate the transmission of specific UL reference signals for UL RRM measurements when any one of the triggering conditions is met, any subset of the triggering conditions is met, or all of the triggering conditions are met.

In operation 906, the control device receives a UL RRM request from the UE. In certain configurations, the UL RRM request may be carried in Uplink Control Information (UCI) or in a Medium Access Control Control Element (MAC-CE). The UCI may be carried in a Physical Uplink Control Channel (PUCCH) or a Physical Uplink Shared Channel (PUSCH).

In certain configurations, the UL RRM request includes at least one of serving RU quality information, information of preferred UL RRM resources, and information on downlink (DL) reception timing availability for a target RU. The serving RU quality information includes at least one of Reference Signal Received Power (RSRP) or mobility information. The information of preferred UL RRM resources indicates at least one of preferred or supported UL RRM resources.

In certain configurations, the information on DL reception timing availability for a target RU includes at least one of an indicator indicating whether DL synchronization toward the target RU on a particular frequency, a particular band, or a particular timing advance group (TAG) is done, or an indicator indicating a reference timing to be used for subsequent UL transmissions. The reference timing to be used for subsequent UL transmissions is based on at least one of the following: a reference timing of a specific serving RU, a reference timing of a target timing advance group (TAG) for RU switch, handover, a primary RU addition, or a secondary RU addition, and a reference timing of a target RU for RU switch, handover, a primary RU addition, or a secondary RU addition.

In operation 908, the control device configures specific UL reference signals and the specific UL RRM resources for the UE. In certain configurations, the configurations of the specific reference signals and the specific UL RRM resources include at least one of a UE identifier, an SRS configuration and an SRS resource configuration, a Physical Random Access Channel (PRACH) configuration and a PRACH resource configuration, a payload location, a scrambling code for scrambling a payload, a reference timing for transmission of the specific UL reference signals, a stopping condition for the transmission of the specific UL reference signals, and a transmitting condition of the transmission of the specific UL reference signals.

In certain configurations, the specific UL reference signals are sounding reference signals (SRSs) or preambles. In certain configurations, the PRACH configuration and the PRACH resource configuration include at least one of a transmission location in time domain and a transmission location in frequency domain, a preamble sequence, a preamble format, and a transmission power indicator. In certain configurations, the stopping condition defines at least one of: stopping transmission of the specific UL reference signals in response to receiving a further indication from the control device, stopping the transmission of the specific UL reference signals when a pre-configured number of transmission opportunities is reached, and stopping the transmission of the specific UL reference signals upon a triggered condition being met.

In certain configurations, the transmitting condition defines at least one of: transmitting the specific UL reference signals periodically, and transmitting the specific UL reference signals when a configured triggering condition is met. In certain configurations, the reference timing for the transmission of the specific UL reference signals defines at least one of: a reference timing of a specific serving RU, a reference timing of a target timing advance group (TAG) for RU switch, handover, a primary RU addition, or a secondary RU addition, and a reference timing of a target RU for RU switch, handover, a primary RU addition, or a secondary RU addition.

In operation 910, the control device provides the UE with an indication that the specific UL reference signals transmitted on the specific UL RRM resources are to be monitored at one or more RUs of the wireless communication system.

In operation 912, one or more RUs of the wireless communication system detect the specific UL reference signals transmitted by the UE on the specific UL RRM resources based on a reference timing when the triggering conditions are met at the UE. In operation 914, the one or more RUs measure the specific UL reference signals to obtain measurement results.

In operation 916, the control device makes a decision for a carrier change or a RU change based on the measurement results of the one or more RUs. In certain configurations, the decision for the carrier change or the RU change includes at least one of a RU switch, a handover, a primary RU addition, or a secondary RU addition. In operation 918, the control device indicates a set of selected RUs or carriers for the UE to connect.

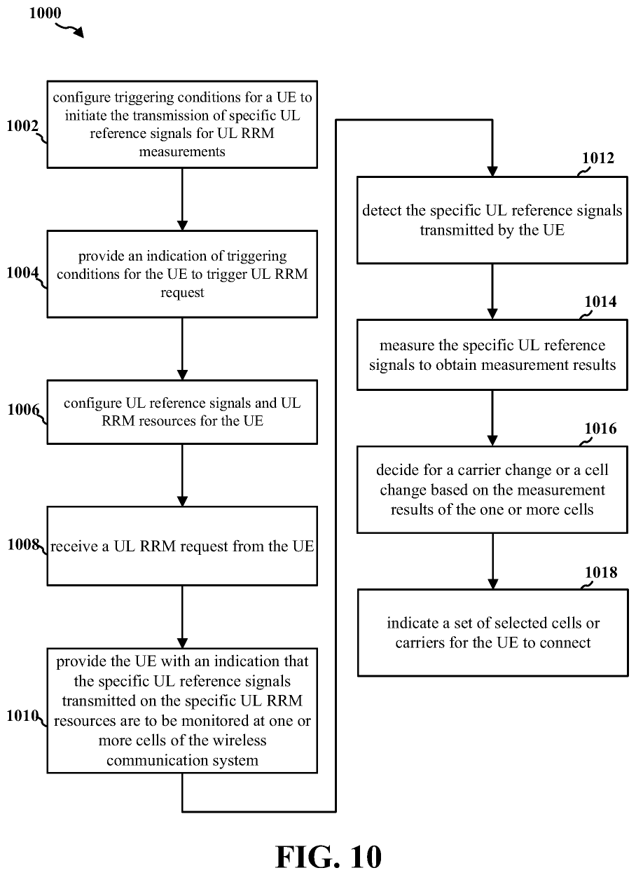

FIG. 10 is a flow chart 1000 of another method (process) for performing UL RRM measurements. The method may be performed by a wireless communication system. In operation 1002, a control device of the wireless communication system configures triggering conditions for a UE to initiate the transmission of specific UL reference signals for UL RRM measurements. In operation 1004, the control device provides an indication of triggering conditions for the UE to trigger the UL RRM request. In operation 1006, the control device configures specific UL reference signals and the specific UL RRM resources for the UE. In operation 1008, the control device receives a UL RRM request from the UE. In operation 1010, the control device provides the UE with an indication that specific UL reference signals transmitted on specific UL RRM resources are to be monitored at one or more RUs of the wireless communication system. In operation 1012, one or more RUs of the wireless communication system detect the specific UL reference signals transmitted by the UE on the specific UL RRM resources based on a reference timing when the triggering conditions are met at the UE. In operation 1014, the one or more RUs measure the specific UL reference signals to obtain measurement results. In operation 1016, the control device makes a decision for a carrier change or a RU change based on the measurement results of the one or more RUs. In certain configurations, the decision for the carrier change or the RU change includes at least one of a RU switch, a handover, a primary RU addition, or a secondary RU addition. In operation 1018, the control device indicates a set of selected RUs or carriers for the UE to connect.

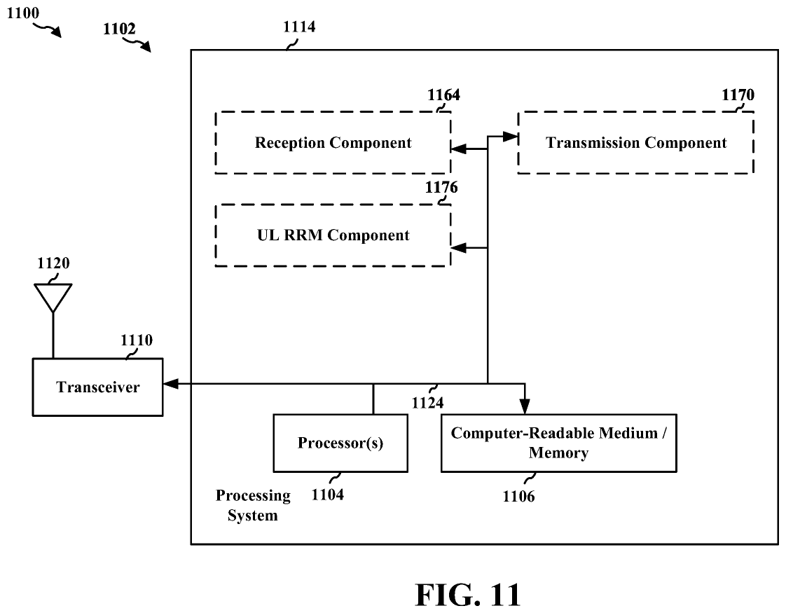

FIG. 11 is a diagram 1100 illustrating an example of a hardware implementation for an apparatus 1102 employing a processing system 1114. The apparatus 1102 may bea base station, a cell, a TRP, a RU, a DU, and/or a CU. The processing system 1114 may be implemented with a bus architecture, represented generally by a bus 1124. The bus 1124 may include any number of interconnecting buses and bridges depending on the specific application of the processing system 1114 and the overall design constraints. The bus 1124 links together various circuits including one or more processors and/or hardware components, represented by one or more processors 1104, a reception component 1164, a transmission component 1170, a UL RRM component 1176, and a computer-readable medium/memory 1106. The bus 1124 may also link various other circuits such as timing sources, peripherals, voltage regulators, and power management circuits, etc.

The processing system 1114 may be coupled to a transceiver 1110, which may be one or more of the transceivers 254. The transceiver 1110 is coupled to one or more antennas 1120, which may be the communication antennas 220.

The transceiver 1110 provides a means for communicating with various other apparatus over a transmission medium. The transceiver 1110 receives a signal from the one or more antennas 1120, extracts information from the received signal, and provides the extracted information to the processing system 1114, specifically the reception component 1164. In addition, the transceiver 1110 receives information from the processing system 1114, specifically the transmission component 1170, and based on the received information, generates a signal to be applied to the one or more antennas 1120.

The processing system 1114 includes one or more processors 1104 coupled to a computer-readable medium/memory 1106. The one or more processors 1104 are responsible for general processing, including the execution of software stored on the computer-readable medium/memory 1106. The software, when executed by the one or more processors 1104, causes the processing system 1114 to perform the various functions described supra for any particular apparatus. The computer-readable medium/memory 1106 may also be used for storing data that is manipulated by the one or more processors 1104 when executing software. The processing system 1114 further includes at least one of the reception component 1164, the transmission component 1170, and the UL RRM component 1176. The components may be software components running in the one or more processors 1104, resident/stored in the computer readable medium/memory 1106, one or more hardware components coupled to the one or more processors 1104, or some combination thereof. The processing system 1114 may be a component of the base station 210 and may include the memory 276 and/or at least one of the TX processor 216, the RX processor 270, and the controller/processor 275.

In one configuration, the apparatus 1102 for wireless communication includes means for performing one or more of the operations of FIGS. 9-10. The aforementioned means may be one or more of the aforementioned components of the apparatus 1102 and/or the processing system 1114 of the apparatus 1102 configured to perform the functions recited by the aforementioned means.

As described supra, the processing system 1114 may include the TX Processor 216, the RX Processor 270, and the controller/processor 275. As such, in one configuration, the aforementioned means may be the TX Processor 216, the RX Processor 270, and the controller/processor 275 configured to perform the functions recited by the aforementioned means

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication in a wireless communication system, comprising:
configuring, by a control device of the wireless communication system, triggering conditions for a user equipment (UE) to initiate transmission of specific uplink (UL) reference signals for UL radio resource management (RRM) measurements;
detecting, at one or more cells of the wireless communication system, the specific UL reference signals transmitted by the UE on specific UL RRM resources based on a reference timing when the triggering conditions are met at the UE;
measuring, at the one or more cells, the specific UL reference signals to obtain measurement results;
deciding for a carrier change or a cell change based on the measurement results of the one or more cells; and
indicating, by the control device to the UE, a set of selected cells or carriers for the UE to connect.

2. The method of claim 1, further comprising:
providing, by the control device to the UE, an indication that the specific UL reference signals transmitted on the specific UL RRM resources are to be monitored at one or more cells of the wireless communication system.

3. The method of claim 1, further comprising:
configuring, by the control device, the specific UL reference signals and the specific UL RRM resources for the UE.

4. The method of claim 3, further comprising:
receiving, at the control device, a UL RRM request from the UE, wherein the configuring the specific UL reference signals and the specific UL RRM resources for the UE is performed in response to receiving the UL RRM request.

5. The method of claim 4, wherein the UL RRM request is carried in Uplink Control Information (UCI) or in a Medium Access Control Control Element (MAC-CE).

6. The method of claim 5, wherein the UCI is carried in a Physical Uplink Control Channel (PUCCH) or a Physical Uplink Shared Channel (PUSCH).

7. The method of claim 4, wherein the UL RRM request includes at least one of serving cell quality information, information of preferred UL RRM resources, and information on downlink (DL) reception timing availability for a target cell.

8. The method of claim 7, wherein the serving cell quality information includes at least one of Reference Signal Received Power (RSRP) or mobility information.

9. The method of claim 7, wherein the information of preferred UL RRM resources indicates at least one of preferred or supported UL RRM resources.

10. The method of claim 7, wherein the information on DL reception timing availability for a target cell includes at least one of:
an indicator indicating whether DL synchronization toward the target cell on a particular frequency, or a particular band, or a particular timing advance group (TAG) is done, or
an indicator indicating a reference timing to be used for subsequent UL transmissions.

11. The method of claim 10, wherein the reference timing to be used for subsequent UL transmissions is based on at least one of the following:
a reference timing of a specific serving cell,
a reference timing of a target timing advance group (TAG) for cell switch, handover, a primary cell addition, or a secondary cell addition, and
a reference timing of a target cell for cell switch, handover, a primary cell addition, or a secondary cell addition.

12. The method of claim 3, further comprising:
subsequent to the configuring the specific UL reference signals and the specific UL RRM resources for the UE, receiving, at the control device, a UL RRM request from the UE;
sending, by the control device to the UE, a confirmation of the configured UL reference signals and the specific UL RRM resources.

13. The method of claim 3, wherein the configuring the specific reference signals and the specific UL RRM resources include configuring at least one of:
a UE identifier,
an SRS configuration and an SRS resource configuration,
a Physical Random Access Channel (PRACH) configuration and a PRACH resource configuration,
a payload location,
a scrambling code for scrambling a payload,
a reference timing for transmission of the specific UL reference signals,
a stopping condition for the transmission of the specific UL reference signals, and
a transmitting condition of the transmission of the specific UL reference signals.

14. The method of claim 13, wherein the PRACH configuration and the PRACH resource configuration include at least one of a transmission location in time domain and a transmission location in frequency domain, a preamble sequence, a preamble format, and a transmission power indicator.

15. The method of claim 13, wherein the stopping condition defines at least one of:
stopping transmission of the specific UL reference signals in response to receiving a further indication from the control device,
stopping the transmission of the specific UL reference signals when a pre-configured number of transmission opportunities is reached, and
stopping the transmission of the specific UL reference signals upon a triggered condition being met.

16. The method of claim 13, wherein the transmitting condition defines at least one of:
transmitting the specific UL reference signals periodically, and
transmitting the specific UL reference signals when a configured triggering condition is met.

17. The method of claim 13, wherein the reference timing for the transmission of the specific UL reference signals defines at least one of:
a reference timing of a specific serving cell,
a reference timing of a target timing advance group (TAG) for cell switch, handover, a primary cell addition, or a secondary cell addition, and
a reference timing of a target cell for cell switch, handover, a primary cell addition, or a secondary cell addition.

18. The method of claim 1, wherein the specific UL reference signals are sounding reference signals (SRSs) or preambles.

19. The method of claim 1, wherein the decision for the carrier change or the cell change includes at least one of a cell switch, a handover, a primary cell addition, or a secondary cell addition.

20. The method of claim 1, further comprising providing, by the control device, an indication of triggering conditions for the user equipment (UE) to trigger the UL RRM request.

21. The method of claim 20, wherein the triggering conditions include at least one of a serving cell quality criterion and a mobility criterion.

22. The method of claim 21, wherein the serving cell quality criterion is based on at least one of Reference Signal Received Power (RSRP), Reference Signal Received Quality (RSRQ), Signal-to-Noise Ratio (SNR), Signal-to-Interference-plus-Noise Ratio (SINR), or hypothetic Block Error Rate (BLER) being no better or worse than a given threshold.

23. The method of claim 21, wherein the mobility criterion is based on a change of at least one of RSRP, RSRQ, SNR, or SINR being no less or larger than a given threshold measured within a certain period of time.

24. The method of claim 21, wherein the triggering conditions define that the UE is to initiate the transmission of specific UL reference signals for UL RRM measurements when:
any one of the triggering conditions is met,
any subset of the triggering conditions is met, or
all of the triggering conditions are met.
